(19) United States
(12) Patent Application Publication
(10) Pub. No.: US 2015/0083754 A1
(43) Pub. Date: Mar. 26, 2015

(54) MODULAR POINT OF CARE DISPENSER SYSTEM

(71) Applicant: GOJO Industries, Inc.,, Akron, OH (US)

(72) Inventors: Scott Theodore Proper, Stow, OH (US); Richard E. Corney, Akron, OH (US)

(21) Appl. No.: 14/495,979

(22) Filed: Sep. 25, 2014

Related U.S. Application Data
(60) Provisional application No. 61/882,944, filed on Sep. 26, 2013.

(51) Int. Cl. B67D 3/00

(52) U.S. Cl. CPC B67D 3/0029
USPC 222/180

(57) ABSTRACT

Apparatuses for dispensing fluid product, such as soap, hand sanitizer, lotion, etc. are provided. A reservoir carrier is configured to be interchangeably attached to one or more mounting brackets of a mounting bracket system to facilitate attachment of the fluid dispensing system to various structures. For example, at times the reservoir carrier may be paired with a hanging bracket to facilitate hanging a fluid dispensing system, including the reservoir carrier, on a bed rail. At other times, the hanging bracket may be swapped with a clamping bracket to facilitate clamping the fluid dispensing system to a counter or IV pole.

### RELATED

This application is a non-provisional filing of and claims priority to U.S. Provisional Application 61/882,944, titled “MODULAR POINT OF CARE DISPENSER SYSTEM” and filed on Sep. 26, 2013, which is incorporated herein by reference.

### FIELD OF THE INVENTION

The current invention pertains to devices for dispensing fluid product, and more specifically to fluid dispensers and holders that can be adapted for installation to a variety of different mounting surfaces.

### BACKGROUND OF THE INVENTION

People entering healthcare facilities, like for example hospitals or nursing homes, frequently acquire infections during the course of their stay. Such infections, which the patients did not originally possess prior to entering the healthcare facility, are termed HAIs (Healthcare-Associated Infections) and represent a serious risk to the health of the patient. In many instances, HAIs result in prolonged stay and additional treatment, and in other instances even loss of life. In addition to the trauma imposed on the patient and their family, HAIs add significant financial burden to the healthcare facility, which incurs the cost of treatment.

There is significant evidence that good hand hygiene can prevent the spread of HAIs. Washing with soap and clean water assists in preventing the transmission of germs, as does the use hand sanitizers. Results from studies have lead health organizations like the CDC (Center for Disease Control) and the WHO (World Health Organization) to release guidelines for cleaning and sanitizing hands, which include the use of alcohol based sanitizers.

One guideline, published by the WHO, describes five moments for hand hygiene. This guideline outlines key moments when healthcare workers should clean or sanitize their hands. The five moments include cleaning or sanitizing: before patient contact, before an aseptic procedure, after exposure to bodily fluid, after patient contact, and after contact with patient surroundings.

When sanitizing, healthcare workers typically use wall mounted dispensers. Some dispensers are conveniently located near doorways at the entrance to a patient's room. In other instances, a healthcare worker relies on freestanding bottles to sanitize their hands. However, freestanding bottles are not always conveniently within reach, especially when performing one of the five moments listed above. As such, an opportunity to sanitize may be lost. Moreover, free standing bottles are subject to theft. What is needed is a system for mounting dispensers and dispenser bottles to a variety of locations within the patient's room. The embodiments of the described invention obviate the aforementioned problems.

### SUMMARY OF THE INVENTION

In one embodiment of the subject invention, a fluid dispensing system includes a generally enclosed fluid reservoir for holding a fluid product like soap, hand sanitizer, or lotion. A fluid pump connects to an open end of the reservoir in a fluid tight manner. A nozzle is also included and fluidly connects to the pump. The dispensing system further includes a reservoir carrier, which comprises the housing of the fluid dispensing system. The reservoir carrier includes retaining members for holding the fluid reservoir in a fixed position relative to the reservoir carrier. A system of mounting brackets having interchangeable attachments removably connects to the reservoir carrier for selectively attaching the fluid dispensing system to one of a number of differently configured structures, like for example a countertop and an IV pole. Examples of interchangeable attachments may include clamping brackets or hanging brackets.

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings.

FIG. 1 depicts a perspective view of a fluid dispensing system attached to a pole according to the embodiments of the subject invention.

FIG. 2 depicts a front-side perspective view of a fluid dispensing system according to the embodiments of the subject invention.

FIG. 3 depicts a rear-side perspective view of a fluid dispensing system according to the embodiments of the subject invention.

FIG. 4 depicts a mounting bracket attachment according to the embodiments of the subject invention.

FIG. 5 depicts another mounting bracket attachment according to the embodiments of the subject invention.

FIG. 6 depicts a perspective view of a bottle holder and bottle of fluid product in one mounting orientation according to the embodiments of the subject invention.

FIG. 7 depicts another perspective view of a bottle holder and bottle of fluid product in another mounting orientation according to the embodiments of the subject invention.

FIG. 8 depicts yet another perspective view of a bottle holder and bottle of fluid product in still another mounting orientation according to the embodiments of the subject invention.

FIG. 9 depicts a rear side perspective view of a bottle holder and bottle of fluid product according to the embodiments of the subject invention.

### DETAILED DESCRIPTION

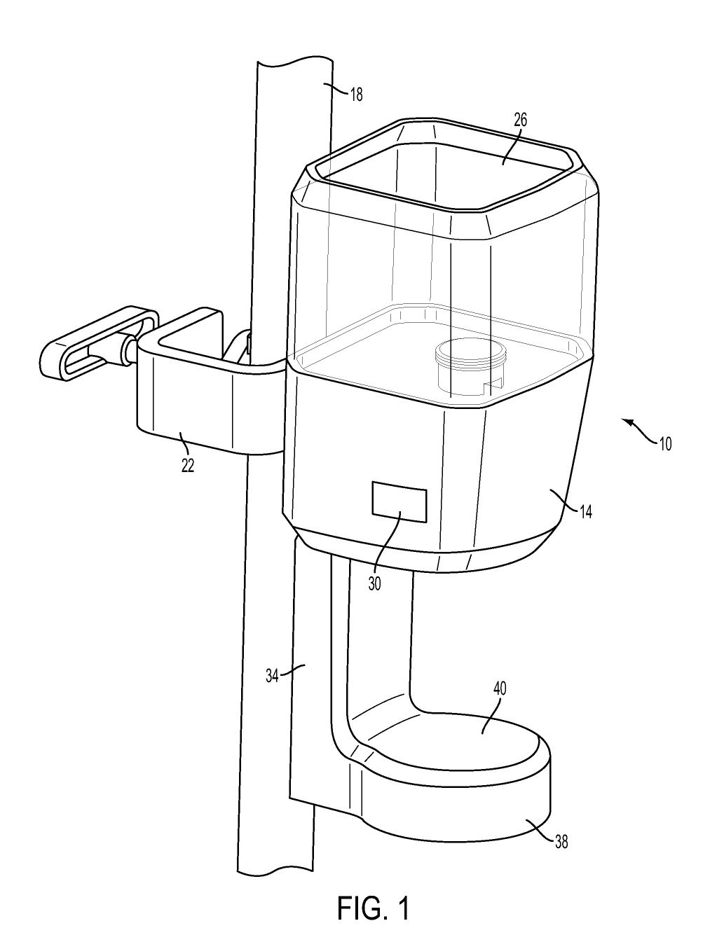

A product dispensing system is depicted in FIG. 1 that dispenses a measured amount of fluid product according to the embodiments of the subject invention. In one exemplary instance, the dispensing system, shown generally at 10, dispenses hand care products like soap, lotion, or sanitizers, although other products may similarly be dispensed from the product dispenser.

In the embodiment depicted in FIG. 1, the dispensing system 10 includes a base 14. The base 14 is made of one or more walls 15 constructed to support the components of the dispensing system 10. Plastic may be used for cost effective manufacturing of the base 14, as well as other components of the system. A fluid reservoir 26 is mounted to the base in an inverted fashion and includes a pump for dispensing product in a manner known in the art. At a rear side 16 of the base 14, a mounting bracket 22 is included for attaching the dispenser to a table 17, IV pole (Intravenous pole) 18, dispenser stand (not shown) or other supporting structure. The mounting bracket 22 shown is modular in design, which is to say that the mounting bracket 22 may be detached from the base 14 and replaced with another type of mounting bracket. In this way, different types of mounting brackets may be used for attaching the dispensing system to different types supporting structures, to be discussed in detail below.

As mentioned, the base 14 is designed to securely receive the fluid reservoir 26. The walls 15 of the base 14 are constructed to form a concave region 20 at an upper end of the dispensing system 10. Structural components, not shown, receive and lock the reservoir 26 in place during use. A latch 30 is included for releasing the fluid reservoir when service is required.

Before installation into the base 14, the reservoir is fitted with a pump (not shown). The pump engages an assembly of linkages and is driven by a motor, not shown, for actuating the pump and dispensing the product. Batteries stored onboard the dispensing system 10 provide power to actuate the pump. For dispersing fluid product in a desired manner, a nozzle (not shown) is attached to an outlet of the pump.

With continued reference to FIG. 1, the base 14 may include a spine 34 or a back plate 34 extending downwardly from the base 14. In one embodiment, the spine 34 is integrally fashioned with the base 14. However, other embodiments are contemplated where the spine 34 may be fastened to the base 14. A drip plate 38 extends from the distal end of the spine 34 and protrudes outward at an angle of approximately 90 degrees, although any acute angle may be chosen with sound judgment. The drip plate 38 is thus positioned at an elevation beneath the pump, and more specifically beneath the nozzle. Persons of skill in the art will understand that the drip plate 38 will capture residual product that may drip from the nozzle during the course of use. Accordingly, the drip plate 38 may be constructed with a concave center 40 to catch fluid product until it evaporates or is cleaned by service personnel.

In one embodiment, the batteries (now shown) may be housed in the body of the drip plate 38. Conductors (also not shown) may be routed from the battery cavity up to the motor located in the base 14. It follows that the conductors run to the motor through the spine 34. In other embodiments, electronic circuitry, e.g. circuit boards, used by the dispensing system 10 may also be housed in the base 14 or spine 34.

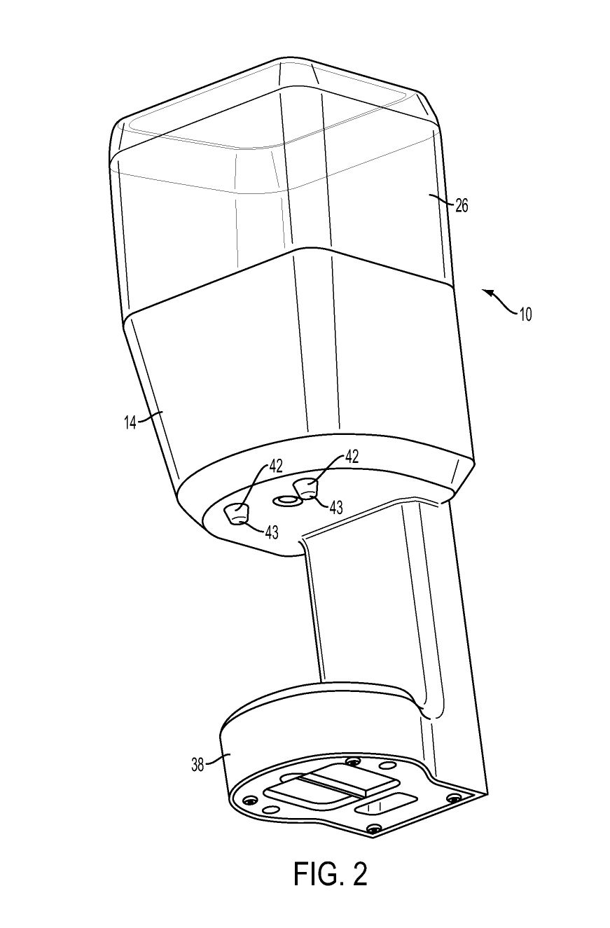

With reference now to FIG. 2, the product dispensing system 10 may be activated without touching the base 14 or any other component of the system. Accordingly, the “touch-free” system may include one or more sensors 42 that detect motion beneath the nozzle. In one exemplary embodiment, the sensors 42 use IR (infrared) technology, which may be installed on an underside on the base 14. To avoid accidental activation, the sensor's field of detection may be orientated, i.e. angled, to detect motion only within the region between the base 14 and the drip plate 38. It should be construed that other types of sensors and/or configurations of sensors may be chosen without departing from the intended scope of coverage of the embodiments of the subject invention.

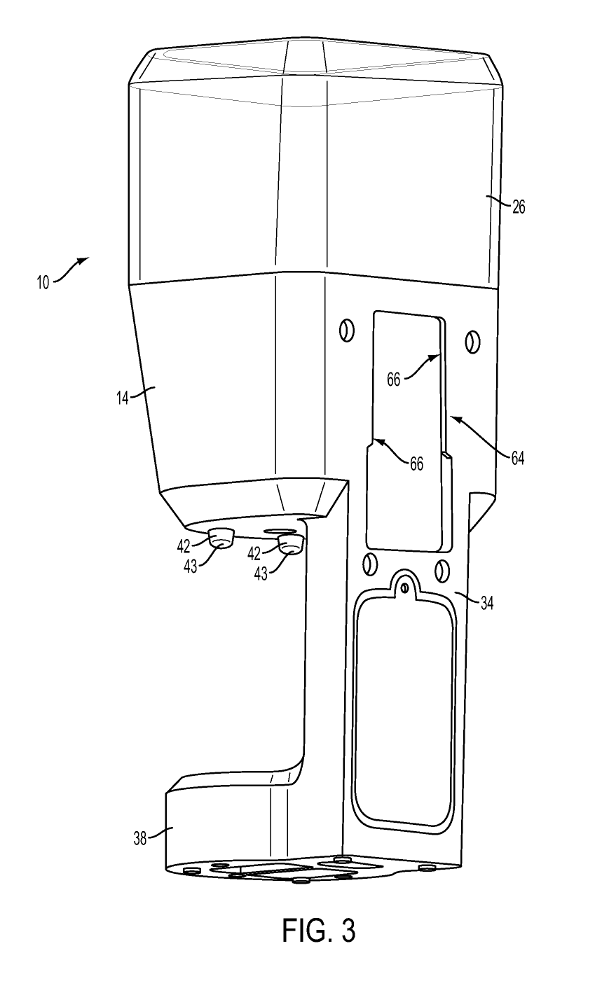

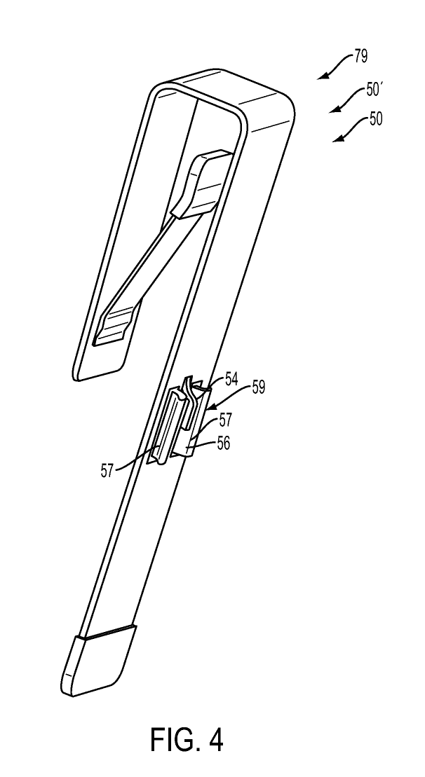

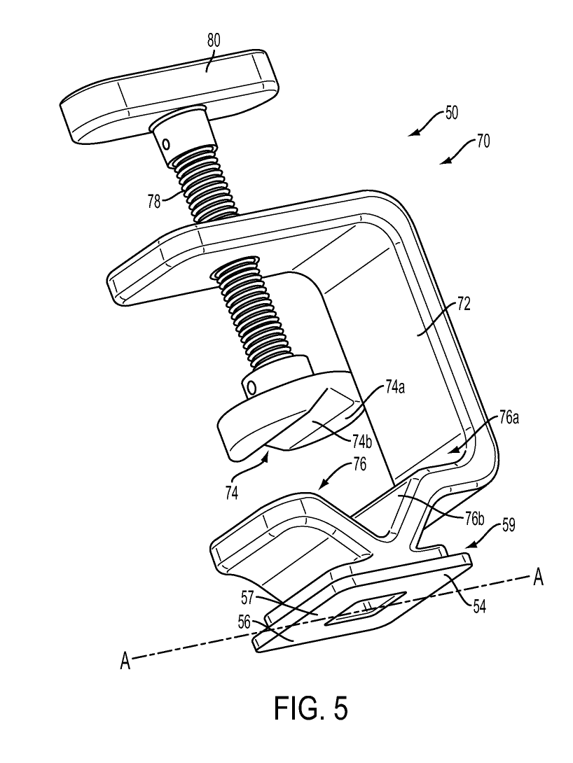

With reference again to FIG. 1 and now to FIGS. 3-5, the product dispensing system 10 includes a modular mounting bracket system. By modular is it meant that multiple interchangeable components are provided that each interlock to the base 14 of the dispensing system for connecting the dispensing system to one or more substantially different surfaces, as previously mentioned. Multiple mounting brackets 50, examples of which are shown in FIGS. 4 and 5, are provided that each interlock to the base 14.

With reference to FIGS. 4 and 5, the mounting brackets 50 include a connecting member 54 extending from a side thereof. The connecting member 54 may be integrally formed with the body of the mounting bracket 50. In one embodiment, the connecting member 54 may comprise a protuberance, referred to as coupling lug 56. The coupling lug 56 may be configured to connect to a matching coupling lug receiver 64 fashioned in the base 14 and/or spine 34. More specifically, the coupling lug 56 interlocks with the coupling lug receiver 64. In one particular embodiment, the coupling lug 56 may include plates or flanges 57 that lock into the base 14. Stated differently, the coupling lug 56 may be constructed having flat surfaces 59 that overlap mating surfaces on the base 14. It is noted here that while the current embodiments primarily describe mechanical interlocks, other forms of interlocking are contemplated including but not limited magnetic interlocking.

With continued reference to FIG. 3, the coupling lug receiver 64 may be constructed by fashioning slots 66 in the base 14 of the dispensing system 10. Accordingly, the flanges 57 slide into the slots 66 thereby interlocking with the base 14. It will be readily understood that the depth of the slots 66 correspond to the thickness of the flanges 57 located on the mounting brackets 50. Additionally, the distance between the slots 66 will also be chosen that corresponds to the spanned width of the flanges 57. Any depth of slots and any width between slots may be chosen as is appropriate for use with the embodiments of the dispensing system described herein.

With reference again to FIG. 5, the coupling lug 56 may be configured for attaching the mounting bracket 50 to the base 14 in more than one mounting orientation. An axis A is defined that passes through the coupling lug 56 of the mounting bracket 50. In a first mounting orientation, axis A is parallel to the slots 66 formed in the base 14. In a second mounting orientation, the mounting bracket 50 is rotated such that axis A is now perpendicular to the slots 66. When attaching the mounting bracket 50 to a particular surface, the user aligns the coupling lug 56 in the desired orientation and installs or slides the mounting bracket 50 into engagement with the coupling lug receiver 64. For example, the dispensing system 10 may be attached to a countertop having a generally horizontal surface. Alternatively, the surface for attaching the dispensing system 10 may be a vertically standing IV pole (intravenous pole). Once in position, the user can tighten a clamp to secure the dispensing system 10 to the surface or in the case of a hanging bracket, reference FIG. 4, allow the dispensing system 10 to hang in place. The user can thus conveniently adapt the dispensing system 10 to attach to multiple disparately configured mounting surfaces.

In the current embodiment, one mounting bracket 50 comprises a clamp 70, or clamping bracket 70. The clamp 70 may include the following constituent parts: rigid clamp body 72, first moveable clamping member 74, second stationary clamping member 76, threaded rod 78, user handle 80, and coupling lug 56. In a manner known in the art, the threaded rod adjusts the distance between the clamping members 74, 76. The clamping members 74, 76 may include a clamping surface that allows the clamp 70 to securely attach to differently shaped surfaces. Specifically, the clamping members 74, 76 may include flat sections 74a, 76a and notched sections 74b, 76b. In the depicted figures the notched sections are V-shaped, although curved or other shaped notches may be incorporated in the clamp 70 without departing from the intended scope of coverage of the embodiments described herein. In this way, the clamping members 74, 76 are adapted to mount not only to different thicknesses of attaching surfaces but also to differently shaped surfaces.

With reference again to the FIG. 4, a second type of mounting bracket 50′ includes a hooked section 80 that allows the mounting bracket 50′ to hang onto, for example, a bed rail or end of the bed (not shown). In this embodiment, the mounting bracket 50′, also called a hanging bracket 79, similarly includes a coupling lug 56 comprised of flanges 57 protruding from a side thereof. It follows that the thickness and spanned width of the flanges 57 correspond to the dimensions of the slots 66. The hanging bracket 79 is thus attached to the base 14 in a manner similar to that of the clamping mounting bracket 70. Mounting brackets having attaching means other than those described herein will become apparent to person skilled in the art. All such variations are to be construed as falling within the scope of coverage of the claimed invention.

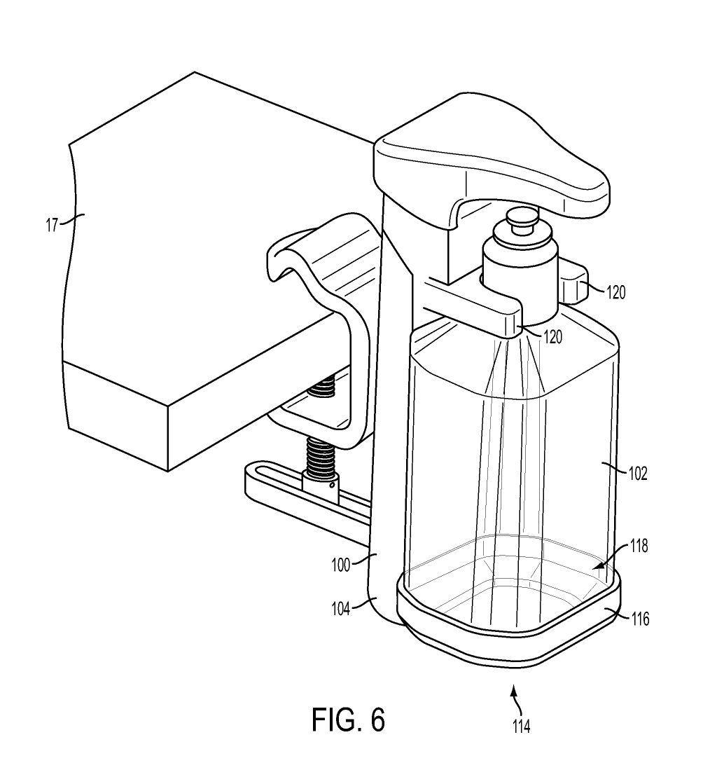

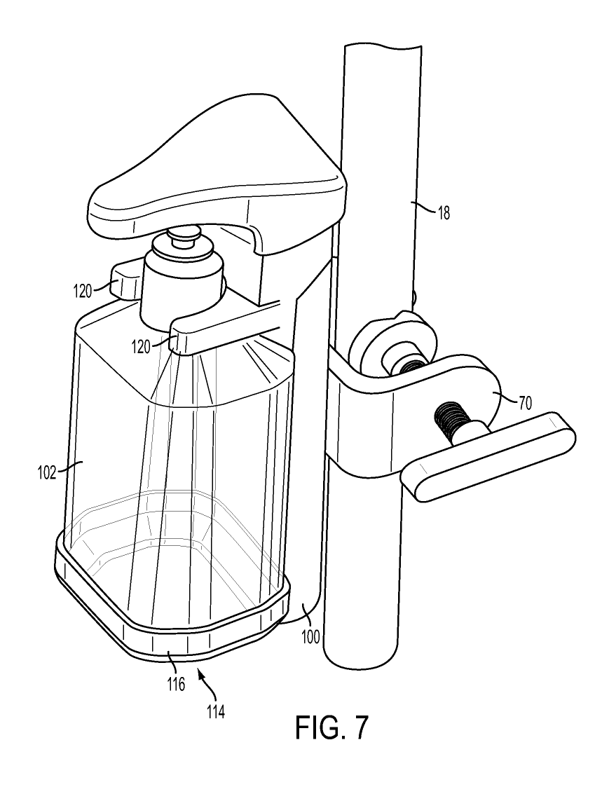

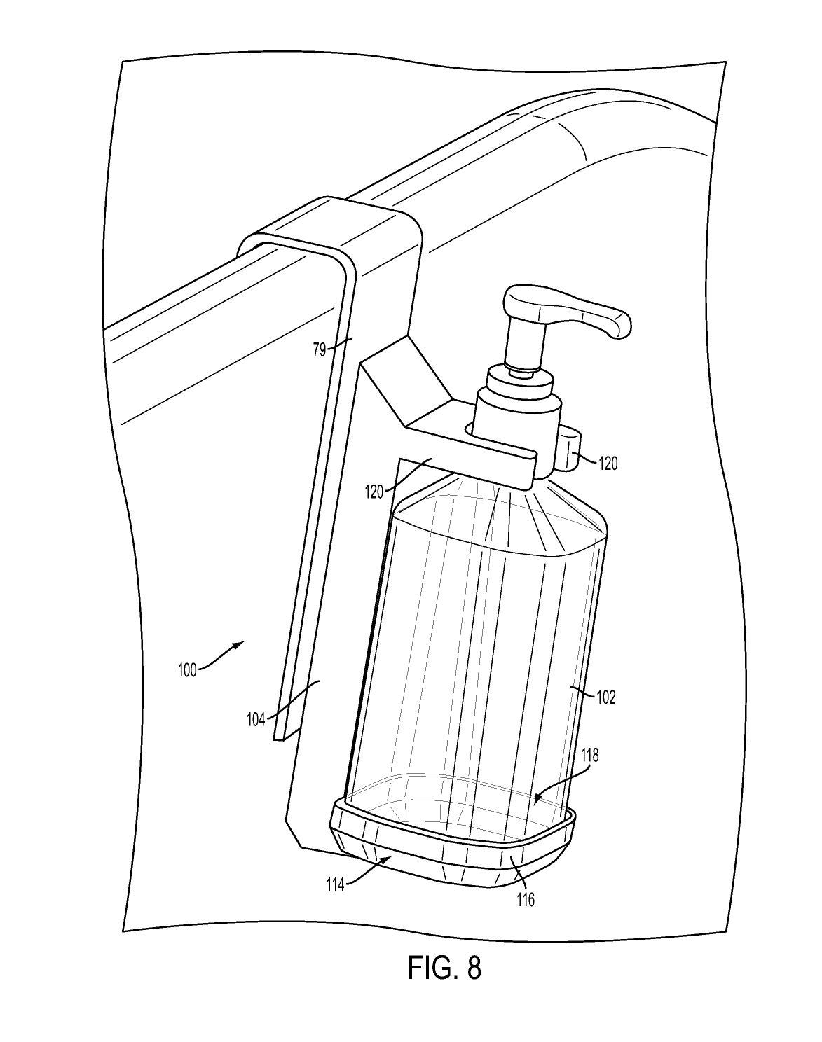

Another embodiment of the subject invention is shown in FIGS. 6-8. In this embodiment, a dispensing system 100 includes a bottle carrier 104, or reservoir carrier 104, and a prepackaged bottle of fluid product 102. It will be understood that the prepackaged bottle of fluid product 102, hereafter referred to as bottle 102, is readily replaceable and moreover is functional for use as a stand-alone unit. However, as previously stated, the short comings of a stand-alone unit are overcome by the various embodiments of the subject invention described herein.

The bottle carrier 104 includes a frame 112, also termed housing 112, constructed from plastic or other suitable material. A base 114 extends from one end of the housing 112 and is rigidly attached thereto for supporting the bottle 102. Side walls 116 or ledges 116 may be included that extend upward from the base 114, forming a bowl or cup 118 configured to further hold the bottle 102 in place with respect to the bottle carrier. At a distal end of the base 114, arms 120 extend forward from the base 114. The arms 120 are design to at least partially surround the bottle 102 and add support for holding the bottle 102 in place during use. In an alternate embodiment, the arms 120 are formed to interconnect and lock together, positively holding the bottle 102 in place.

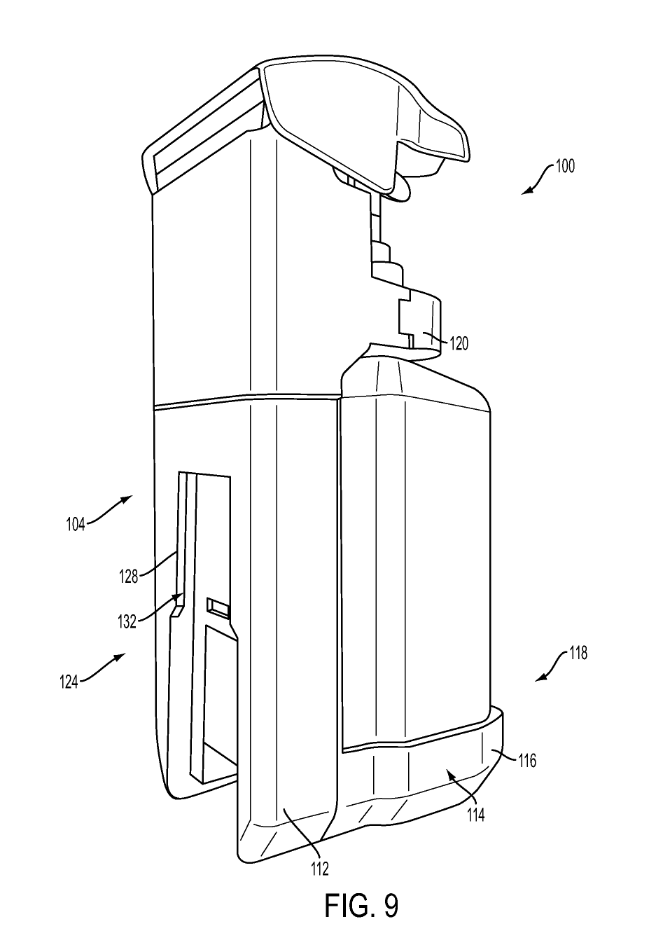

With continued reference to FIGS. 6-8 and now also to FIG. 9, the back side 124 of bottle carrier 104 includes a coupling lug receiver 128 similar to that of the coupling lug receiver 64 fashioned in the base 14. Slots 132 making up the coupling lug receiver 128 may correspond dimensionally to the coupling lugs 56 of the mounting brackets 50 described above.

From the aforementioned description of the embodiments, it can be seen that by providing a plurality of interchangeable mounting brackets, the dispensing system 10, 100 is capable of attaching to multiple structures each being significantly different. In this way, the dispensing system 10, 100 is made to be conveniently positioned near an end user, e.g. healthcare worker, in a wide array of places.

It will be apparent to those skilled in the art that various modifications and variations can be made to the embodiments described herein without departing from the spirit and the scope of the claimed subject matter. Thus it is intended that the specification cover the modifications and variations of the various embodiments described herein provided such modifications and variations come within the scope of the appended claims and their equivalents.

What is claimed is:

1. A fluid dispensing system, comprising:
a fluid reservoir for containing a fluid product, the reservoir having an open end;
a pump fluidly connected with the open end of the fluid reservoir;
a nozzle fluidly connected to the pump;
a reservoir carrier having one or more retaining members for holding the fluid reservoir in a fixed position relative to the reservoir carrier; and
a mounting bracket system having interchangeable attachments removably connected to the reservoir carrier for selectively attaching the fluid dispensing system to one of multiple disparate associated structures.

2. The fluid dispensing system as defined in claim 1, wherein said mounting bracket system comprises:
a hanging bracket comprising a hooked surface for hanging the fluid dispensing system onto a first associated structure of the multiple disparate associated structures; and
a clamping bracket comprising a clamp having a selectively adjustable clamping surface for clamping the fluid dispensing system onto a second associate structure of the multiple disparate associated structures.

3. The fluid dispensing system as defined in claim 2, wherein the reservoir carrier comprises a slot and the clamping bracket comprises a coupling lug configured to interlock with the slot.

4. The fluid dispensing system as defined in claim 3, wherein the coupling lug has a polygonal shaped perimeter that interlocks the coupling lug to the slot in one of first angular orientation or a second angular orientation, the first angular orientation about 90 degrees apart from the second angular orientation.

5. The fluid dispensing system as defined in claim 1, where the reservoir carrier comprising a coupling lug receiver integrally fashioned thereon and wherein said mounting bracket system comprises:
a first mounting bracket comprising a first coupling lug for selectively connecting the first mounting bracket to the coupling lug receiver, the first mounting bracket having a first mounting surface for attaching the fluid dispensing system onto a first associated structure of the multiple disparate associated structures; and
a second mounting bracket comprising a second coupling lug for selectively connecting the second mounting bracket to the coupling lug receiver in replacement of the first mounting bracket, the second mounting bracket having a second mounting surface, different than the first mounting surface, for attaching the fluid dispensing system onto a second associated structure of the multiple disparate associated structures.

6. The fluid dispensing system as defined in claim 5, wherein the coupling lug receiver is defined by at least one recess formed in the reservoir carrier and the first coupling lug has a coupling surface that connects to the at least one recess in one of a plurality of angular orientations.

7. The fluid dispensing system as defined in claim 6, wherein the range of angular orientations is 90 degrees or less.

8. The fluid dispensing system as defined in claim 5, wherein:
the coupling lug receiver comprises one or more slots formed in the reservoir carrier; and
the first coupling lug comprises a plate that selectively interlocks to the one or more slots in one of at least two different angular orientations.

9. The fluid dispensing system as defined in claim 5, wherein the first mounting surface comprises:
a rigid U-shaped bracket member having a bracket member wall; and
a spring biased member extending from the bracket member wall.

10. The fluid dispensing system as defined in claim 1, further comprising:
a sensor operatively connected to the reservoir carrier, the sensor operable to detect motion proximal to the nozzle for use in automatically dispensing the fluid product;
a locomotion device operatively connected to activate the pump; and
an onboard power storage device supplying power to at least one of the sensor or the locomotion device.

11. The fluid dispensing system as defined in claim 10, further comprising:
a drip plate for collecting residual fluid product, the drip plate being fixedly connected to the reservoir carrier at a mounting elevation below the nozzle.

12. The fluid dispensing system as defined in claim 1, further comprising:
a data collection module comprising a sensor to detect activation of the pump, the sensor having an output indicating activation of the pump; and
at least one electrical circuit in communication with the sensor, the at least one electrical circuit having a transmitter for downloading the output of the sensor to an associated network.

13. A fluid dispensing system, comprising:
a reservoir carrier to which a fluid reservoir is selected attached, the reservoir carrier having a coupling surface for mating with a plurality of interchangeable attachments for selectively attaching the fluid dispensing system to one of multiple disparate associated structures.

14. The fluid dispensing system as defined in claim 13, wherein the reservoir carrier comprises a coupling lug receiver defined by at least one recess formed in the reservoir carrier, the coupling surface disposed within the at least one recess.

15. The fluid dispensing system as defined in claim 14, wherein the coupling lug receiver comprises one or more slots formed in the reservoir carrier.

16. The fluid dispensing system as defined in claim 15, further comprising a mounting bracket system associated with the plurality of interchangeable attachments, the mounting bracket system comprising a plate that selectively interlocks to the one or more slots.

17. The fluid dispensing system as defined in claim 13, further comprising a mounting bracket system associated with the plurality of interchangeable attachments, the mounting bracket system comprising:
a hanging bracket comprising a hooked surface for hanging the fluid dispensing system onto a first associated structure of the multiple disparate associated structures; and
a clamping bracket comprising a clamp having a selectively adjustable clamping surface for clamping the fluid dispensing system onto a second associate structure of the multiple disparate associated structures.

18. The fluid dispensing system as defined in claim 13, further comprising:
a sensor operatively connected to the reservoir carrier, the sensor operable to detect motion for use in automatically dispensing a fluid product from the fluid reservoir.

19. The fluid dispensing system as defined in claim 18, further comprising:
an onboard power storage device supplying power to the sensor.

20. A fluid dispensing system, comprising:
a reservoir carrier having one or more retaining members for holding a fluid reservoir in a fixed position relative to the reservoir carrier, the reservoir carrier comprising a first mating structure; and
a mounting bracket system having interchangeable attachments removably connected to the reservoir carrier for selectively attaching the fluid dispensing system to one of multiple disparate associated structures, the mounting bracket system comprising a second mating structure configured to be paired with the first mating structure to mate the reservoir carrier with the mounting bracket system.
